(19) United States
(12) Patent Application Publication
(10) Pub. No.: US 2026/0365272 A1
(43) Pub. Date: Nov. 19, 2026

(54) BIKE FRAME ADAPTER

(71) Applicant: Also, Inc., Palo Alto, CA (US)

(72) Inventors: Adam Christopher BENDER, San Francisco, CA (US); Jonathan Louis HALL, Menlo Park, CA (US); Arth Nireshkumar PATEL, San Jose, CA (US); Mark Oliver Dixon KAUFMAN, San Jose, CA (US)

(73) Assignee: Also, Inc., Palo Alto, CA (US)

(21) Appl. No.: 19/206,900

(22) Filed: May 13, 2025

(51) Int. Cl. B62K 19/36; B62J 43/13; B62J 45/42; B62J 50/21; B62K 19/40; B62M 6/40

(52) U.S. Cl. CPC B62K 19/36; B62J 45/42; B62J 50/21; B62J 43/13; B62K 19/40; B62M 6/40

(57) ABSTRACT

A bike frame adapter for an electric bike can include a housing defining a mount recess. The mount recess can receive a portion of the top frame. The bike frame adapter can include an anchor disposed at least partially in the housing. The anchor can move between a first position and a second position. The bike frame adapter can include an actuator coupled with the anchor. The actuator can move the anchor between the first position and the second position.

### INTRODUCTION

Vehicles can include passengers and can be used to convey the passengers from one location to another.

### SUMMARY

At least one aspect is directed to a bike frame adapter. The bike frame adapter can include a housing defining a mount recess. The mount recess can receive a portion of the top frame. The bike frame adapter can include an anchor disposed at least partially in the housing. The anchor can move between a first position and a second position. The bike frame adapter can include an actuator coupled with the anchor. The actuator can move the anchor between the first position and the second position.

At least one aspect is directed to a bike frame adapter system. The bike frame adapter system can include a top frame including a mount plate. The bike frame adapter system can include a housing defining a mount recess. The mount recess can receive the mount plate. The bike frame adapter system can include an anchor disposed at least partially in the housing. The anchor can move between a first position and a second position. The bike frame adapter system can include an actuator coupled with the anchor. The actuator can move the anchor between the first position and the second position.

At least one aspect is directed to a method. The method can include providing a bike frame adapter. The bike frame adapter can include a housing defining mount recess. The mount recess can receive a portion of the top frame. The bike frame adapter can include an anchor disposed at least partially in the housing. The anchor can move between a first position and a second position. The bike frame adapter can include an actuator coupled with the anchor. The actuator can move the anchor between the first position and the second position.

At least one aspect is directed to a method of coupling a bike frame adapter with a top frame. The method can include providing a housing. The housing can define a mount recess. The method can include disposing an anchor at least partially in the housing. The anchor can move between a first position and a second position. The method can include disposing a portion of the top frame in the mount recess. The method can include coupling an actuator with the anchor. The method can include moving the anchor between the first position and the second position using the actuator.

At least one aspect is directed to a bike frame adapter. The bike frame adapter can include a mount to engage at least a portion of a top frame. The bike frame adapter can include a sensor coupled with the mount. The sensor can detect the top frame. The bike frame adapter can include an actuator coupled with the mount. The actuator can couple the mount with the top frame based on the detection of the top frame.

At least one aspect is directed to a bike frame adapter system. The bike frame adapter system can include a top frame including a mount plate. The bike frame adapter system can include a mount to receive at least a portion of the mount plate. The bike frame adapter system can include a sensor coupled with the mount. The sensor can detect the top frame. The bike frame adapter system can include an actuator coupled with the mount. The actuator can couple the mount with the top frame in response to the sensor detecting the top frame.

At least one aspect is directed to a method. The method can include providing a bike frame adapter. The bike frame adapter can include a mount to engage at least a portion of a top frame. The bike frame adapter can include a sensor coupled with the mount. The sensor can detect the top frame. The bike frame adapter can include an actuator coupled with the mount. The actuator can couple the mount with the top frame based on the detection of the top frame.

At least one aspect is directed to a method of coupling a bike frame adapter with a top frame. The method can include providing a mount. The method can include engaging a portion of the top frame using the mount. The method can include coupling a sensor with the mount. The method can include detecting the top frame using the sensor. The method can include coupling an actuator with the mount. The method can include coupling the mount with the top frame in response to detecting the top frame using the actuator.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an electric bike, in accordance with some aspects.

FIG. 2 depicts a schematic diagram of a bike, in accordance with some aspects.

FIG. 3 depicts a perspective view of a portion of a bike, in accordance with some aspects.

FIG. 4 depicts a perspective view of a bike frame adapter, in accordance with some aspects.

FIG. 5 depicts a perspective view of a top frame of a bike, in accordance with some aspects.

FIG. 6 depicts cross-sectional views of the bike frame adapter, in accordance with some aspects.

FIG. 7 depicts an exploded view of a bike frame adapter, in accordance with some aspects.

FIG. 8 depicts a perspective view of a bike frame adapter, in accordance with some aspects.

FIG. 9 depicts an exploded view of a bike frame adapter, in accordance with some aspects.

FIG. 10 depicts a cross-sectional view of a bike frame adapter, in accordance with some aspects.

FIG. 11 depicts a cross-sectional view of a bike frame adapter, in accordance with some aspects.

FIG. 12 depicts a perspective view of a bike frame adapter, in accordance with some aspects.

FIG. 13 depicts a cross-sectional view of a bike frame adapter, in accordance with some aspects.

FIG. 14 depicts cross-sectional views of a bike frame, in accordance with some aspects.

FIG. 15 depicts cross-sectional views of an actuator hook of a bike frame adapter, in accordance with some aspects.

FIG. 16 depicts an example method of receiving a bike frame adapter, in accordance with some aspects.

FIG. 17 depicts an example method of coupling a bike frame adapter with a top frame, in accordance with some aspects.

FIG. 18 depicts an example method of coupling a bike frame adapter with a top frame, in accordance with some aspects.

### DETAILED DESCRIPTION

Following below are more detailed descriptions of various concepts related to, and implementations of, methods, apparatuses, and systems of a bike frame adapter. The various concepts introduced above and discussed in greater detail below may be implemented in any of numerous ways.

This technical solution is generally directed to a bike frame adapter system for a bike, and specifically an electric bike (“e-bike”). The bike frame adapter system allows for a single bike to receive various attachments such as, for example, a variety of seat designs. The bike frame adapter system can include a top frame that can attach with the bike through a bike frame adapter. The bike frame adapter can receive the top frame and then lock the frame into place. The top frame can come in various arrangements that can be swappable or interchangeable such that the different top frames can provide different seat designs for the bike.

The disclosed solutions have a technical advantage of providing a bike frame adapter that can take advantage of the bike's energy storage systems to couple the swappable frame with the bike. For example, the bike frame adapter can include a sensor that can detect the presence of the top frame. The bike frame adapter can also include an electric actuator to couple the top frame with the bike in response to the sensor detecting the top frame. The bike frame adapter further includes a mechanical fail safe to keep the swappable frame coupled with the bike with no electrical power. For example, if the bike runs out of power, the actuator can stay in the locked position and can prevent the top frame from decoupling from the bike.

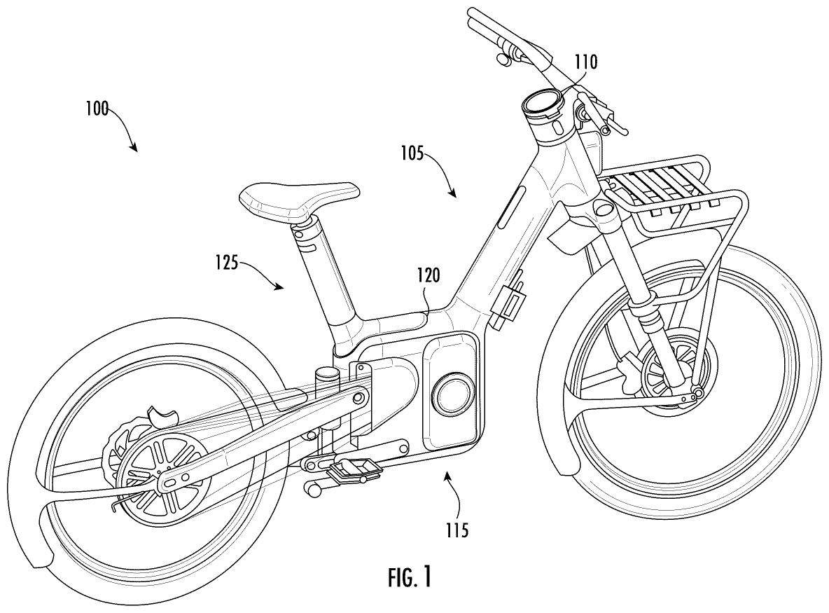

FIG. 1 depicts an example electric bicycle (e.g., bike) 100. The electric bike 100 (e.g., bike) can be or can include any vehicle that can carry at least one rider, is operable by at least one motor, and includes at least one wheel or similar movement component (e.g., single rider bicycles, tandem bicycles, cargo bicycles, motor-assist bicycles, pedicabs, electric-assist bicycles, road bicycles, mountain bicycles, or unicycles, among others). The bike 100 can be fully electric or partially electric (e.g., pedal-powered) and further, the bike 100 can be fully autonomous, partially autonomous, semi-autonomous, or unmanned. The bike 100 can also be human operated or non-autonomous.

The bike 100 can include at least one frame 105 (e.g., chassis). The frame 105 can support various components of the bike 100. The bike 100 can include at least one display 110 (e.g., graphical user interface). For example, the display 110 can be disposed along or extend from the frame 105 of the bike 100. The display 110 can communicate with one or more components of the bike 100. The display 110 can display various information about the bike 100. For example, the display 110 can display a current speed, a distance traveled, a battery level, a trip time, or other information that can be beneficial for an operator of the bike 100. The display 110 can receive one or more user inputs from an operator of the bike 100. For example, the display 110 can receive a user input to activate and/or deactivate one or more components of the bike 100. The display 110 can receive a user input to turn off the bike 100 by deactivating an energy storage device (e.g., battery, capacitor, etc.) of the bike 100.

The bike 100 can include at least one apparatus, shown as drive unit 115. The frame 105 can be coupled with or extend from the drive unit 115. The drive unit 115 can house various components of the bike 100. For example, the drive unit 115 can house an energy storage device (e.g., battery, etc.) or a controller of the bike 100.

The bike 100 can include at least one top frame 125. The top frame 125 can be coupled with the frame 105. For example, the bike 100 can include at least one connection point 120. The top frame 125 can be coupled with the frame 105 via the connection point 120. The connection point 120 can be disposed along or be defined by the frame 105. For example, the connection point 120 can be or define a recess to receive a part of the top frame 125.

The top frame 125 can include various designs. For example, the top frame 125 can include a single seat for an operator of the bike 100 to sit on. The top frame 125 can include a single seat and a storage rack. The storage rack can store and/or carry one or more items, allowing the items to be transported by the bike 100. The top frame 125 can include a two-person seat for the operator of the bike 100 and a passenger to sit on. The various designs of the top frame 125 enable the operator of the bike 100 to customize the bike 100 based on their needs. For example, if the operator requires storage for groceries, the operator may choose to use the top frame 125 with a single seat and a storage rack. The various top frames 125 can be interchangeable with the bike 100.

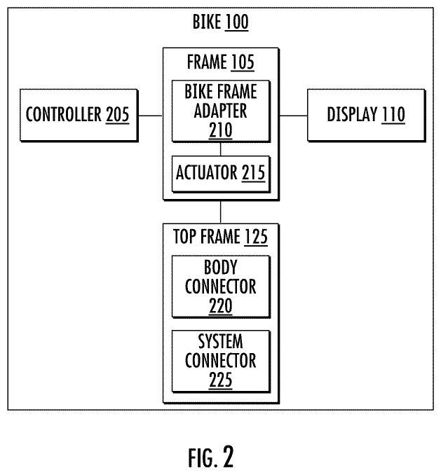

FIG. 2 depicts a schematic diagram of the bike 100. The bike 100 can include at least one controller 205. For example, the controller 205 can be housed within the drive unit 115. The controller 205 can distribute electrical power to different components of the bike 100. For example, the controller 205 can distribute electrical power to the display 110. The bike 100 can include at least one actuator 215. The controller can distribute electrical power to the actuator 215. The controller 205 can be configured to control the various components of the bike 100. For example, the controller 205 can be configured to control the actuator 215, the bike frame adapter 210, the body connector 220, or other components of the bike 100 coupled with the controller 205. The controller 205 can receive or transmit commands to or from one or more components of the bike 100. For example, the controller 205 can transmit a command to the display 110 to cause the display 110 to display information relating to the bike 100. In response to the display 110 receiving a user input, the controller 205 can receive a command from the display 110 to transmit a command to a bike frame adapter 210 of the bike 100.

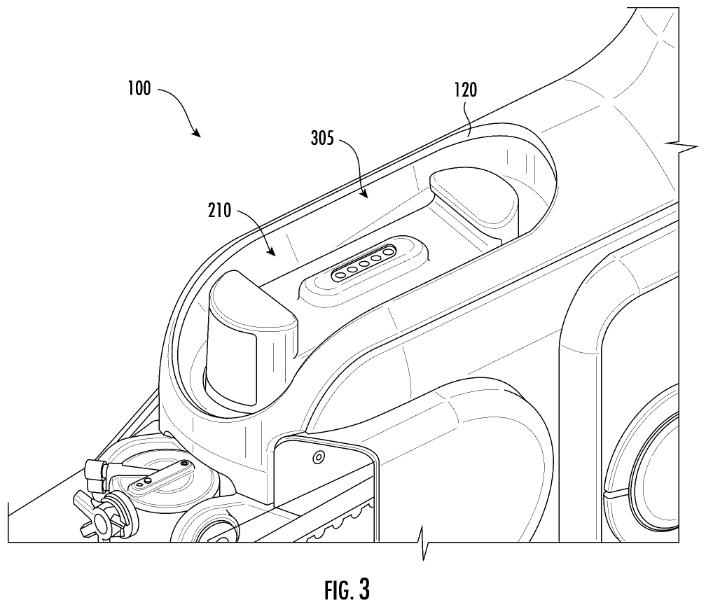

The bike 100 can include at least one bike frame adapter 210. The bike frame adapter 210 can be disposed along, in, or be a part of the frame 105. For example, and as shown in FIG. 3 among others, the bike frame adapter 210 can be disposed in the connection point 120 of the frame 105. The bike frame adapter 210 can receive the top frame 125. The bike frame adapter 210 can couple the top frame 125 with the frame 105 to enable an operator to operate the bike 100.

The bike frame adapter 210 can store or include one or more components. For example, the bike frame adapter 210 can include at least one actuator 215. For example, the actuator 215 can be disposed within the bike frame adapter 210. The actuator 215 can be disposed outside of the bike frame adapter 210. The actuator 215 can be coupled (e.g., electrically) with the bike frame adapter 210.

The top frame 125 can include at least one body connector 220. For example, the body connector 220 can be disposed along an end of the top frame 125. The body connector 220 can be coupled with the frame 105. For example, the bike frame adapter 210 can receive the body connector 220 to couple the top frame 125 with the frame 105 of the bike 100.

The top frame 125 can include at least one system connector 225. The system connector 225 can couple electrical components of the top frame 125 with electrical components of the bike 100.

FIG. 3 depicts a perspective view of an example portion of the bike 100. Particularly, FIG. 3 depicts a perspective view of the connection point 120 with a top frame 125 not coupled with the bike 100. The connection point 120 can include or define at least one cavity 305 (e.g., recess). For example, the cavity 305 can extend inward from the frame 105.

The bike frame adapter 210 can be disposed in the cavity 305. For example, the bike frame adapter 210 can be recessed within the connection point 120. The bike frame adapter 210 can be coupled with the frame 105 using one or more fasteners (e.g., screws, nuts and bolts, etc.).

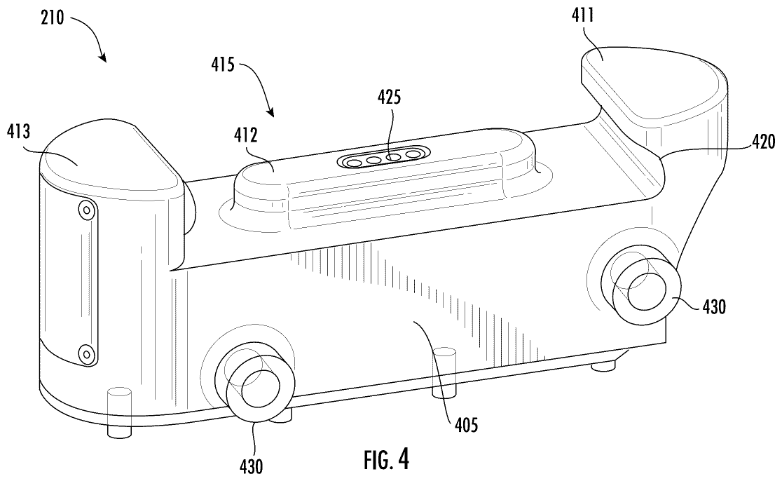

FIG. 4 depicts an example bike frame adapter 210. The bike frame adapter 210 can include at least one housing 405. The housing 405 can store or include one or more components of the bike frame adapter 210. For example, the housing 405 can store the actuator 215.

The bike frame adapter 210 can define or include at least one mount 410. The mount 410 can extend outward from the housing 405 toward the top frame 125. The mount 410 can receive or interact with at least a portion of the top frame 125. The bike frame adapter 210 can include a front mount 411, a middle mount 412, and a rear mount 413 that extend from the housing 405. The middle mount 412 can be disposed along the housing 405 between the front mount 411 and the rear mount 413. The front mount 411, the middle mount 412, and the rear mount 413 can each include a height. For example, the front mount 411 and the rear mount 413 can both include a first height, while the middle mount 412 can include a second height that is less than the first height.

The bike frame adapter 210 can define or include at least one mount recess 415 (e.g., recess). The mount recess 415 can be defined by the front mount 411 and the rear mount 413. The middle mount 412 can be disposed within the mount recess 415. The mount recess 415 can receive at least a portion of the top frame 125. With the portion of the top frame 125 disposed in the mount recess 415, a front portion of the top frame 125 can interface with the front mount 411 and a rear portion of the top frame 125 can interface with the rear mount 413.

The housing 405 can define or include at least one pocket 420. Particularly, at least one mount 410 of the housing 405 can define or include the pocket 420. For example, the pocket 420 can extend into at least one of the front mount 411 or the rear mount 413. The pocket 420 can receive at least a portion of the top frame 125. For example, a front portion of the top frame 125 can be disposed in the pocket 420 of the front mount 411.

The bike frame adapter 210 can include at least one sensor 425. The sensor 425 can be disposed along or coupled with at least one of the mounts 410. For example, the sensor 425 can be coupled with the middle mount 412. The sensor 425 can detect the top frame 125. For example, with at least a portion of the top frame 125 disposed in the mount recess 415, the sensor 425 can detect the presence of the top frame 125. The sensor 425 can detect information about the top frame 125. For example, the sensor 425 can detect a type of the top frame 125, among other information.

The sensor 425 can engage or couple with the system connector 225 of the top frame 125. For example, the sensor 425 can include at least one pin (e.g., pogo pin). The pin can be contact the system connector 225 (e.g., an electrically conducting surface) of the top frame 125 to complete an electrical circuit of the bike frame adapter 210. As a result of the electrical circuit being complete, the sensor 425 can detect the top frame 125. For example, with at least a portion of the top frame 125 disposed in the mount recess 415, the pin of the sensor 425 can contact the electrically system connector 225 and detect the top frame 125. The sensor 425 can include a variety of sensors capable of detecting the top frame 125. For example, the sensor 425 can include a proximity sensor, displacement sensor, touch sensor, distance sensor, or an electro-mechanical sensor, such as a button.

The housing 405 can include at least one coupling point 430. For example, the housing 405 can include a first coupling point 430 and a second coupling point 430 that extend at least partially through the housing 405. The coupling points 430 can receive at least one fastener (e.g., screw, nuts and bolts, etc.) to couple the bike frame adapter 210 with the frame 105. The coupling point 430 can receive at least one connection (e.g., wire, cable, etc.) to electrically couple the components of the bike frame adapter 210 (e.g., the actuator 215, the sensor 425, etc.) with the controller 205, the display 110, or the components of the drive unit 115.

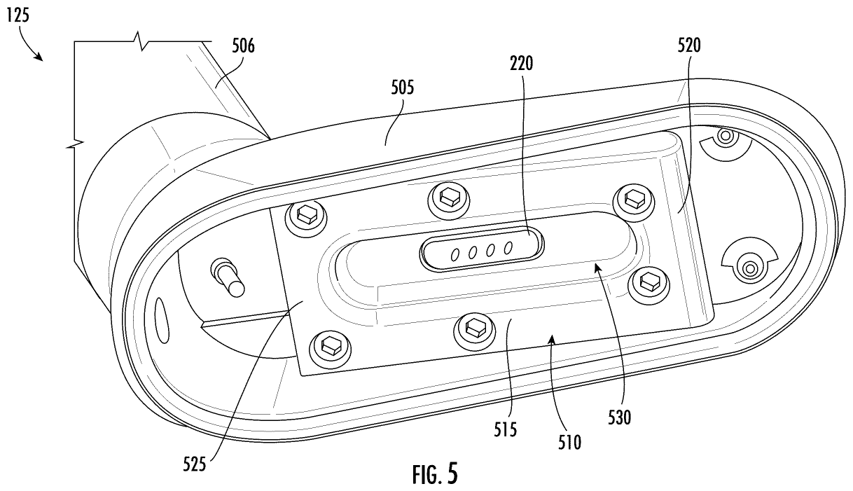

FIG. 5 depicts an example of the top frame 125. The top frame 125 can include a top frame body 505 and a top frame member 506. The top frame body 505 can be disposed at an end of the top frame member 506. The top frame body 505 can extend from the end of the top frame member 506.

The top frame body 505 can define at least one frame cavity 510 (e.g., recess). The frame cavity 510 can extend into the top frame body 505 toward the top frame member 506. With the top frame 125 coupled with the bike 100 via the cavity 305 of the connection point 120, the frame cavity 510 can surround (e.g., encapsulate) the bike frame adapter 210.

The top frame body 505 can be or include the body connector 220. The body connector 220 can include various components to couple the top frame 125 with the bike 100. For example, the body connector 220 can include at least one mount plate 515. The mount plate 515 can be coupled with the top frame body 505. The mount plate 515 can be at least partially disposed in the frame cavity 510. The mount plate 515 can be disposed the mount recess 415 of the bike frame adapter 210. For example, with the top frame 125 coupled with the bike 100 via as the connection point 120, the mount recess 415 can receive the mount plate 515. For example, the mount plate 515 can be disposed between the front mount 410 and the rear mount 410.

The mount plate 515 can include at least one lip 520 (e.g., protrusion). The lip 520 can be disposed at or along an end of the mount plate 515. The lip 520 can extend at least partially out of the frame cavity 510. The lip 520 can be at least partially received by the pocket 420. For example, with the connection point 120 coupled with the top frame 125, the pocket 420 can receive the lip 520. With the lip 520 disposed in the pocket 420, the lip 520 can assist in keeping the top frame 125 coupled with the frame 105 as the actuator secures the top frame 125 to the frame 105.

The mount plate 515 can include at least one protrusion 525. The protrusion 525 can extend from an opposite end of the mount plate 515 from the lip 520. The protrusion 525 can be at least partially received by the frame cavity 510. For example, with the connection point 120 coupled with the top frame 125, the frame cavity 510 can receive the protrusion 525.

The mount plate 515 can include at least one recess 530. For example, the recess 530 can extend into the mount plate 515 toward the top frame 125. The recess 530 can receive the middle mount 412. For example, as the connection point 120 receives the top frame 125. With the middle mount 412 disposed within the recess 530, the recess 530 extends at least partly around the middle mount 412.

The mount plate 515 can include or be coupled to the system connector 225. For example, the system connector 225 can be disposed within or extend at least partly from the recess 530. The system connector 225 can contact the sensor 425. For example, the system connector 225 can contact the sensor 425 with the middle mount 412 disposed in the recess 530. The system connector 225 can, for example, include at least one electrically conducting surface. In another example, the system connector 225 can include at least one pin to be received by or contact the pin of the sensor 425. system connector 225 can include a sensor to detect the bike frame adapter 210.

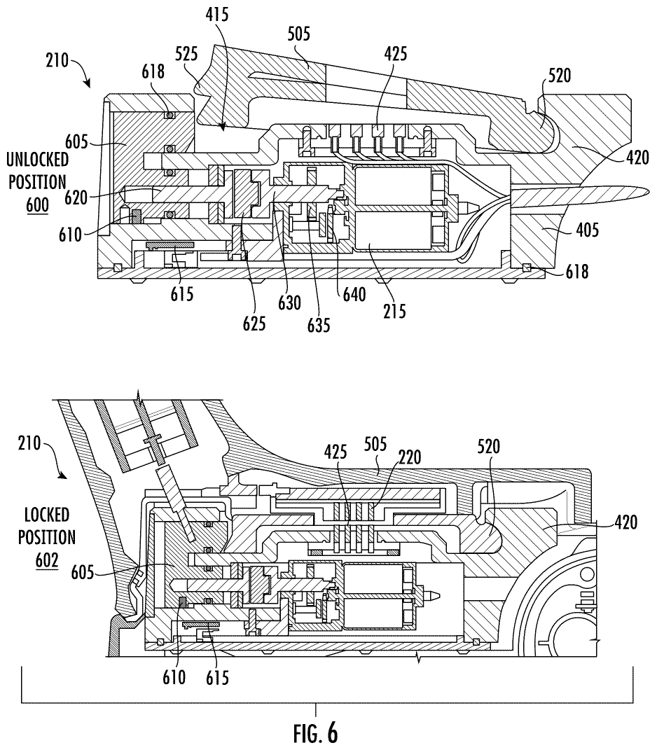

FIG. 6 depicts a cross-sectional view of the bike frame adapter 210 in an unlocked position 600 and a locked position 602. In the unlocked position, the bike frame adapter 210 can be not coupled with the top frame 125. In the locked position, the bike frame adapter 210 can be coupled with the top frame 125.

The bike frame adapter 210 can include at least one movable element, shown as anchor 605. The anchor 605 can be any element or object capable of moving between positions. For example, the anchor 605 can be molded from any material (e.g., plastic) and can have any shape (e.g., a c-shape). The anchor 605 can be at least partially disposed within the housing 405. The anchor 605 can be movable within the housing 405. For example, the actuator 215 can move the anchor 605 between a first position (e.g., unlocked position 600) and a second position (e.g., locked position 602). The actuator 215 can move the anchor 605 from the first position to the second position in response to the sensor 425 detecting the top frame 125 or the display 110 receiving a user input. The actuator 215 can move the anchor 605 by pulling or pushing the anchor 605. For example, the actuator 215 can cause the anchor 605 to slide relative to the housing 405.

In the first position, the anchor 605 can be fully disposed within the housing 405. In the second position, the anchor 605 can extend at least partially from the housing 405 into the mount recess 415 such that the anchor 605 applies a force to the top frame 125. For example, in the second position, the anchor 605 can apply a force to the protrusion 525 of the top frame 125. The force applied by the anchor 605 to the protrusion 525 can prevent the top frame 125 from being decoupled from the frame 105. The top frame 125 can be decoupled from the frame 105 after the actuator 215 moves the anchor 605 from the second position to the first position in response to the display 110 receiving a user input.

The bike frame adapter 210 can include at least one sensed element 610. The sensed element 610 can be, for example, a magnet. The sensed element 610 can be coupled with the anchor 605. For example, the part of the anchor 605 that is disposed within the housing 405 can include the sensed element 610. The sensed element 610 can move with the anchor 605 between the first position and the second position.

The bike frame adapter 210 can include at least one position sensor 615. The position sensor 615 can be disposed within the housing 405. The position sensor 615 can be, adjacent to the anchor 605 and the sensed element 610. The position sensor 615 can be electrically coupled with the controller 205. The position sensor 615 can, for example, include a hall-effect sensor or another sensor capable of sensing a magnetic field of the sensed element 610 (e.g., a magnet). The sensor 615 can determine the proximity of the sensed element 610 to the sensor 615. The controller 205 can determine a position of the anchor based on the proximity. The controller 205 can move the actuator 215 until the sensed element 610 is at desired position relative to the position sensor 615.

The bike frame adapter 210 can include at least one seal 618. The seal 618 can be made of plastic or another polymer material. The seal 618 can, for example, include an o-ring, a flat seal, and/or a gasket. The seal 618 can be placed between two components of the bike frame adapter 210 to prevent impurities outside of the bike 100 from getting within the housing 405 and damaging the components therein. For example, the seal 618 can be adjacent to the anchor 605 and the mount 410. In another example, the seal 618 can be placed between the bike frame adapter 210 and the cavity 305.

The bike frame adapter 210 can include at least one drive member 620 (e.g., screw). For example, the drive member 620 can drive the anchor 605 to move between the first position and the second position. The drive member 620 can be disposed within the housing 405. The drive member 620 can be coupled with the anchor 605. For example, the drive member 620 can be threadably coupled with the anchor 605. For example, rotation of the drive member 620 can cause linear movement of the anchor 605.

The bike frame adapter 210 can include at least one coupler 625. The coupler 625 can be coupled with the drive member 620. The bike frame adapter 210 can include at least one actuator arm 630. The actuator arm 630 can drive the motion of the drive member 620. The actuator arm 630 can be disposed within the housing 405. The actuator arm 630 can be coupled with the actuator 215. The actuator 215 can cause the actuator arm 630 to move. The coupler 625 can be disposed between the actuator arm 630 and the drive member 620 The actuator arm 630 can be coupled with the coupler 625. The actuator arm 630 can extend at least partially within the actuator 215. The actuator arm 630 can include at least one arm gear 635. The arm gear 635 can be coupled with the actuator arm 630 such that the arm gear 635 is disposed within the actuator 215. The arm gear 635 can include, for example, a spur gear, a helical gear, and/or another gear capable of performing the operations described herein.

The actuator 215 can move the drive member 620, the coupler 625, and the actuator arm 630 to cause the anchor 605 to move between the first position and the second position. The actuator 215 can cause the movement in response to the sensor 615 detecting the top frame 125. For example, the actuator 215 can cause the drive member 620 to rotate in a first direction and a second direction. Rotation of the drive member 620 in a first direction can cause the anchor 605 to move in a first lateral direction. Rotation of the drive member 620 in the second direction can cause the anchor 605 to move in a second lateral direction.

The housing 405 can include at least one actuator 215. The actuator 215 can be or include a rotational actuator to generate rotational movement. The drive member 620, among other components, can convert the rotational movement into linear movement to cause the anchor 605 to slide along the housing 405. The actuator 215 can be or include a linear actuator, a gearmotor, or another actuator to generate linear movement. The actuator 215 can include at least one actuator gear 640. For example, the actuator gear 640 can be disposed within the actuator 215. The actuator 215 can rotate the actuator gear 640 between a locked position and an unlocked position. In the locked position the anchor 605 and the connected components (e.g., the drive member 620, coupler 625, and the actuator arm 630) can be locked in the second position.

In response to the anchor 605 being in the second position, the arm gear 635 can be adjacent to the actuator gear 640. The actuator 215 can then, for example, rotate the actuator gear 640 to the locked position, causing the actuator gear 640 to contact the arm gear 635, locking the arm gear 635, the actuator arm 630, the coupler 625, the drive member 620, and the anchor 605 in the second position. In another example, in response to the anchor 605 being in the second position, the actuator gear 640 can be in contact with the arm gear 635 without the actuator 215 rotating the actuator gear 640. In response to the arm gear 635 being in contact with the actuator gear 640, the top frame 125 can be coupled with the frame 105.

The top frame 125 can remain coupled with the frame 105 until the display 110 receives a user input. In response to an energy storage device of the bike 100 running out of energy, the arm gear 635 can remain locked with the actuator gear 640. As a result, the coupler 625, the drive member 620, and the anchor can remain in the second position, preventing the top frame 125 from decoupling from the frame 105.

In response to the display 110 receiving a user input, the top frame 125 can decouple from the frame 105. For example, in response to the display 110 receiving the user input, the actuator 215 can move the actuator gear 640 from the locked position to the unlocked position. With the actuator gear 640 in the unlocked position, the actuator 215 causes the anchor 605 to move from the second position to the first position, allowing the top frame 125 to be decoupled from the frame 105.

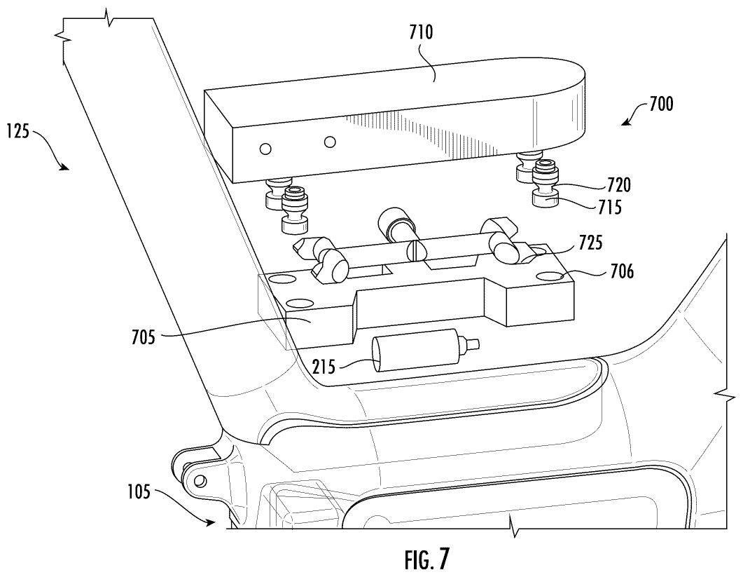

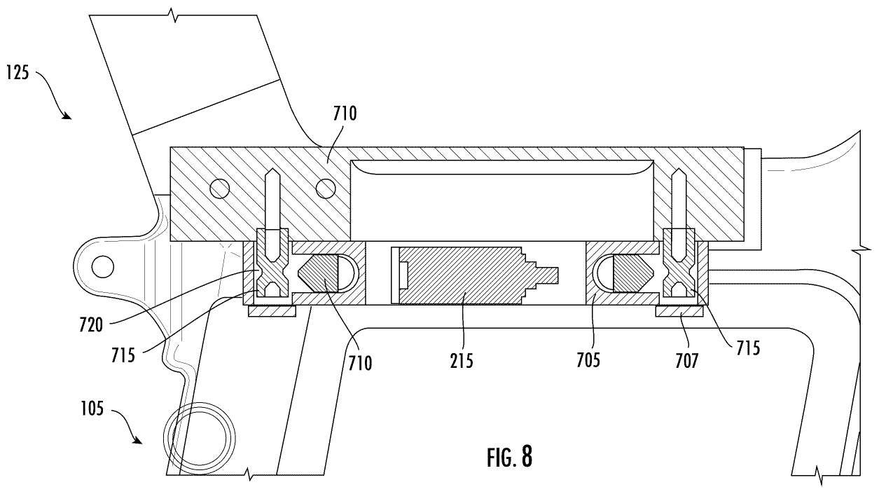

FIGS. 7 and 8 depict an example of a bike frame adapter 700. The bike frame adapter 700 can couple a top frame 125 with the bike 100 (e.g., similar to bike frame adapter 210, among others). The bike frame adapter 700 can include at least one mount 705 (e.g., base plate). The mount 705 can be disposed along or partially within the frame 105. The mount 705 can be configured to receive at least a portion of the top frame 125. For example, the mount 705 can define at least one aperture 706. The aperture 706 can be configured to receive a portion of the top frame 125. The mount 705 can include a plurality of apertures 706.

The bike frame adapter 700 can include at least one sensor 707. The sensor 707 can be coupled with the mount 705. The sensor 707 can be the same as or similar to the sensor 425, among others. For example, the sensor 707 can be configured to detect when at least a portion of a top frame 125 is disposed in the cavity 305 of the connection point 120 of the bike 100.

The bike frame adapter 700 can include at least one actuator 215. The actuator 215 can be coupled with the mount 705. The actuator 215 can be disposed within the mount 705. The actuator 215 can be configured to couple the mount 705 with or decouple the mount 705 from the top frame 125. For example, the actuator 215 can actuate in response to the sensor 707 detecting the top frame 125 or in response to the display 110 receiving a user input.

The bike frame adapter 700 can include at least one lock member 725 (e.g., wedge). The lock member 725 can be disposed in the mount 705. The lock member 725 can be coupled with the actuator 215. For example, actuation of the actuator 215 can cause the lock member 725 to move between a first position (e.g., unlocked) and a second position (locked). The actuator 215 can move the lock member 725 between the first position and the second position in response to the sensor 707 detecting the top frame 125 or the display 110 receiving a user input.

The top frame 125 can include at least one top plate 710. The top plate 710 can be disposed at least partially within the frame cavity 510. The top plate 710 can be coupled with the top frame 125 and the mount 705.

The top frame 125 can include at least one pin 715. The pin 715 can extend outward from the top plate 710 toward the frame 105. The pin 715 can be at least partially received by the mount 705. For example, the pin 715 can be at least partially disposed within an aperture 706 of the mount 705. The top frame 125 can include a plurality of pins 715. For example, the top frame 125 can include a first pin 715, a second pin 715, a third pin 715, and a fourth pin 715. Each pin 715 can correspond with an aperture 706 of the mount 705.

The pin 715 can include at least one pin recess 720 (e.g., pin groove). The pin recess 720 can receive an end of the lock member to couple the top frame 125 with the bike 100. The pin recess 720 can extend at least partially inward from an outer surface of the pin 715. For example, the center of the pin 715 can include a first thickness and either end of the pin 715 can include a second thickness greater than the first thickness. One or more of the first pin 715, the second pin 715, the third pin 715, and the fourth pin 715 can include a pin recess 720. For example, the first pin 715 can include a first pin recess 720, the second pin 715 can include a second pin recess 720, the third pin 715 can include a third pin recess 720, and the fourth pin 715 can include a fourth pin recess 720.

The lock member 725 moving from the first position to the second position can include the lock member 725 linearly traversing within the mount 705 toward the pin 715. The lock member 725 moving from the second position to the first position can include the lock member 725 linearly traversing within the mount 705 away from the pin 715. The bike frame adapter 700 can include a first lock member 725, a second lock member 725, a third lock member, 725 and a fourth lock member 725. One or more of the first lock member 725, the second lock member 725, the third lock member 725, and the fourth lock member 725 can be moved by the actuator 215. For example, the first lock member 725, the second lock member 725, the third lock member 725, and the fourth lock member 725 can be simultaneously moved by the actuator 215.

In the first position, the lock member 725 can not contact the pin 715. For example, in the first position, the lock member 725 can be disposed in the mount 705 and can not extend into a aperture 706. The pin 715 can move in and out of the aperture 706 with the lock member 725 in the first position. In the second position, the lock member 725 can contact the pin 715. For example, in the second position, the lock member 725 can extend into the aperture 706 and into a pin recess 720. The lock member 725 can apply a force to the pin 715. The force applied to the pin 715 by the lock member 725 can couple the frame 105 with the top frame 125. In the second position, at least a portion of the first lock member 725, the second lock member 725, the third lock member 725, and the fourth lock member 725 can be disposed within the first pin recess 720, the second pin recess 720, the third pin recess 720, and the fourth pin recess, respectively. The lock member 725 can remain in the second position until the display 110 receives a user input to decouple the top frame 125 from the frame 105.

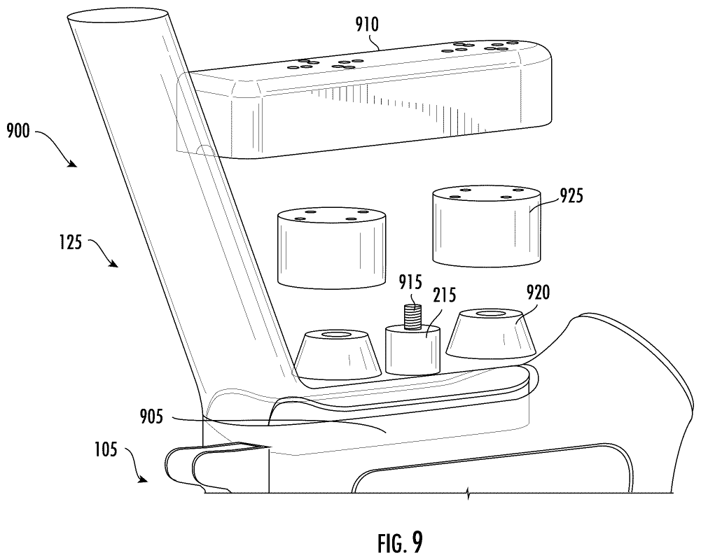

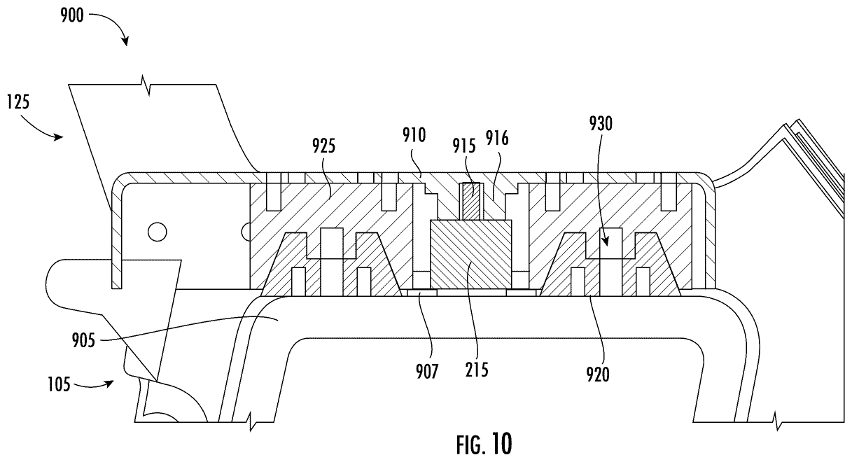

FIGS. 9 and 10 depict an example of a bike frame adapter 900. The bike frame adapter 900 can couple a top frame 125 with the bike 100 (e.g., similar to bike frame adapter 210, among others). The bike frame adapter 900 can include at least one mount 905. The mount 905 can be the same as or similar to mount 705, among others. The mount 905 can be disposed along or partially within the frame 105. The mount 905 can be configured to receive at least a portion of the top frame 125.

The bike frame adapter 900 can include at least one sensor 907. The sensor 907 can be coupled with the mount 905. The sensor 907 can be the same as or similar to the sensor 425, among others. For example, the sensor 907 can be configured to detect when at least a portion of the top frame 125 is disposed in the cavity 305 of the connection point 120 of the bike 100.

The bike frame adapter 900 can include at least one actuator 215. The actuator 215 can be coupled with the mount 905. The actuator 215 can be disposed within the mount 905. The actuator can be configured to couple the mount 905 with or decouple the mount 905 from the top frame 125. For example, the actuator 215 can actuate in response to the sensor 907 detecting the top frame 125 or in response to the display 110 receiving a user input.

Top frame 125 can include at least one top plate 910. The top plate 910 can be disposed at least partially within the frame cavity 510. The top plate 710 can be coupled with the top frame 125 and the mount 905.

The bike frame adapter 900 can include at least one drive member 915 (e.g., screw). The drive member 915 can be coupled with the actuator 215. The drive member 915 can couple the top frame 125 with the bike frame adapter 900. The actuation of the actuator 215 can cause the drive member 915 to move. For example, the actuator 215 can cause the drive member 915 to rotate. Rotation of the drive member 915 in a first direction can couple the top frame 125 with the bike frame adapter 900 (e.g., hold the top frame 125 in a locked position). Rotation of the drive member 915 in a second direction can decouple the top frame 125 from the bike frame adapter 900 (e.g., move the top frame 125 to an unlocked position). The actuator 215 can move the drive member 915 in response to the sensor 907 detecting the top frame 125 or the display 110 receiving a user input.

The actuator 215 moving the drive member 915 can cause the top plate 910 to move between a first position and a second position. For example, the top plate 910 can include at least one coupling component 916. The coupling component 916 can engage with the drive member 915 to couple the top frame 125 with the bike frame adapter 900. For example, the coupling component 916 can be threadably engaged with the drive member 915. Rotation of the drive member 915 can couple or decouple the top frame 125 with the bike frame adapter 900 via the coupling component 916. For example, the actuator 215 can rotate the drive member 915 a first direction to cause the top plate 910 to move toward the mount 905. The actuator can rotate the drive member 915 in a second direction that is opposite to the first direction to cause the top plate 910 to move away from the mount 905. In the first position, the top plate 910 can be in contact with the mount 905. In the second position, the top plate 910 can be disposed away from the mount 905 and decoupled from the drive member 915.

The bike frame adapter 900 can include at least one projection 920. The projection 920 can be coupled with the mount 905. The projection 920 can extend upward from the mount 905 toward the top frame 125. The projection 920 can include have any shape. For example, the projection 920 can have a truncated conical shape. For example, the projection 920 can include a shape that is at least partially tapered.

The bike frame adapter 900 can include a first projection 920 and a second projection 920. The first projection 920 can be coupled with a first end of the mount 905. The second projection 920 can be coupled with a second end of the mount 905. The first end of the mount 905 can be opposite to the second end of the mount 905. The first projection 920 can include a first shape. The second projection can include a second shape. The first shape can be the same as the second shape. For example, both the first projection 920 and the second projection 920 can include a truncated conical shape. The first shape can be different from the second shape.

The top frame 125 can include at least one engagement element 925. The engagement element 925 can include or define a cavity 930. The cavity 930 can receive at least a part of the projection 920. The engagement element 925 and a corresponding projection 920 can facilitate proper alignment of the top frame 125 with the bike frame adapter 900. The engagement element 925 can be coupled with the top plate 910. The engagement element 925 can extend downward from the top plate 910 toward the frame 105. The engagement element 925 can at least partially surround (e.g., enclose) the projection 920. With the top plate 910 in the second position, the engagement element 925 can at least partially surround the projection 920. The top frame 125 can include a first engagement element 925 and a second engagement element 925. With the top plate 125 in the second position, the first engagement element 925 can at least partially surround the first projection 920 and the second engagement element 925 can at least partially surround the second projection 920.

The cavity 930 can extend into the engagement element 925 toward the top plate 910. The cavity 930 can have any shape. For example, the cavity 930 can have a truncated conical shape. For example, the cavity 930 can include a shape that is at least partially tapered. The shape can correspond to the shape of the projection 920. For example, both the cavity 930 and the projection 920 can include a truncated conical shape. The cavity 930 can at least partially surround the projection 920. For example, with the top plate 910 in the second position, the cavity 930 can at least partially surround the projection 920.

A first engagement element 925 can define a first cavity 930 and a second engagement element 925 can define a second cavity 930. The first cavity 930 can extend into the first engagement element 925. The second cavity 930 can extend into the second engagement element 925. The first cavity 930 can include a first shape. The second cavity 930 can include a second shape. The first shape can be the same as the second shape. For example, both the first cavity 930 and the second cavity 930 can include a truncated conical shape. The first shape can be different than the second shape. The first shape can correspond to the shape of the first projection 920. The second shape can correspond to the shape of the second projection 920. With the top plate 910 in the second position, the first cavity 930 can at least partially surround the first projection 920. With the top plate 910 in the second position, the second cavity 930 can at least partially surround the second projection 920.

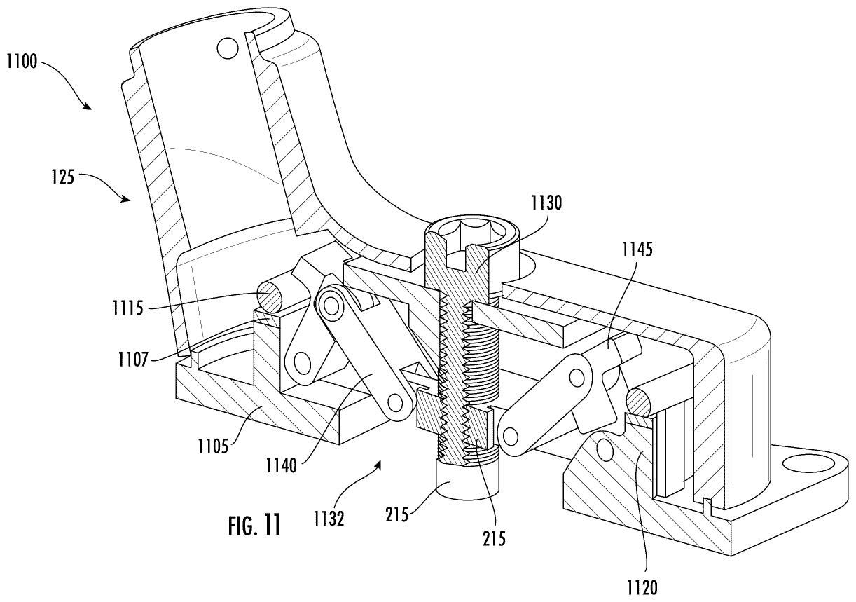

FIG. 11 depicts an example of a bike frame adapter 1100. The bike frame adapter 1100 can couple a top frame 125 with the bike 100 (e.g., similar to the bike frame adapter 210, among others). The bike frame adapter 1100 can include at least one mount 1105. The mount 1105 can be the same as or similar to the mount 705, among others. For example, the mount 1105 can be disposed in the cavity 305 of the connection point 120 of the bike 100. The mount 1105 can be configured to engage with at least a portion of the top frame 125.

The bike frame adapter 1100 can include at least one sensor 1107. The sensor 1107 can be coupled with the mount 1105. The sensor 1107 can be the same as or similar to the sensor 425, among others. For example, the sensor 1107 can be configured to detect when at least a portion of a top frame 125 is in contact with the mount 1105.

The bike frame adapter 1100 can include at least one actuator 215. The actuator 215 can be coupled with the mount 1105. The actuator 215 can be disposed within the mount 1105. The actuator 215 can be configured to couple the top frame 125 with or decouple the top frame 125 from the mount 1105. For example, the actuator 215 can actuate in response to the sensor 1107 detecting the top frame 125 or in response to the display 110 receiving a user input.

The top frame 125 can include at least one pin 1115. The pin 1115 can be disposed in the frame cavity 510. The pin 1115 can extend from a sidewall of the frame body 505. For example, the pin 1115 can extend between a first side wall and a second side wall of the frame body 505. The top frame 125 can include a plurality of pins 1115. For example, the top frame 125 can include a first pin 1115 and a second pin 1115.

The bike frame adapter 1100 can include at least one protrusion 1120. The protrusion 1120 can extend from the mount 1105 toward the top frame 125. The protrusion 1120 can extend into the frame cavity 510 of the top frame 125 with the top frame 125 coupled with the bike frame adapter 1100. The protrusion 1120 can engage with (e.g. interface with) at least a portion of the pin 1115. For example, with the top frame 125 coupled with the bike 100, the protrusion 1120 can contact the pin 1115. The bike frame adapter 1100 can include a plurality of protrusions 1120. For example, the bike frame adapter 1100 can include a first protrusion 1120 and a second protrusion 1120. The first protrusion 1120 can extend upward from a first end of the mount 1105. The second protrusion 1120 can extend upward from a second end of the mount 1105. The first end of the mount 1105 can be opposite to the second end of the mount 1105. With the bike top frame 125 coupled with the bike 100, the first protrusion 1120 can contact the first pin 1115 and the second protrusion 1120 can contact the second pin 1115.

The bike frame adapter 1100 can include at least one drive member 1130 (e.g., screw). The drive member 1130 can be coupled with the actuator 215. The the actuator 215 can move the drive member 1130 to couple the top frame 125 to and decouple the top frame 125 from the bike frame adapter 1100. The actuator 215 can move the drive member 1130 in response to the sensor 1107 detecting the top frame 125 or the display 110 receiving a user input.

The bike frame adapter 1100 can include at least one link system 1132. The link system 1132 can couple the top frame 125 with the bike frame adapter 1100. The link system 1132 can be coupled with the drive member 1130. For example, the link system 1132 can include at least one coupler 1135. The coupler 1135 can be threadably coupled with the drive member 1130. Movement of the drive member 1130 can cause the link system 1132 to move between a first position and a second position. For example, as the drive member 1130 rotates, the coupler 1135 can move along the drive member 1130. For example, the coupler 1135 can move vertically along the drive member 1130. The coupler 1135 can move along the drive member 1130 toward the top frame body 505. For example, with the actuator 215 rotating the drive member 1130 in a first direction, the coupler 1135 can move toward the top plate 1110. The coupler 1135 can move along the drive member 1130 toward the mount 1105. For example, with the actuator 215 rotating the drive member 1130 in a second direction, the coupler 1135 can move toward the mount 1105.

The link system 1132 can include at least one linkage 1140. The linkage 1140 can be coupled with the coupler 1135. The linkage 1140 can move based on the movement of the drive member 1130. A first end of the linkage 1140 can extend outward from the coupler 1135. The linkage 1140 can pivot about the coupler 1135. For example, with the first end of the linkage 1140 coupled with the coupler 1135, the second end of the linkage 1140 can move vertically. The linkage 1140 can contact one or more components of the bike frame adapter 1100 or the top frame 125.

The linkage 1140 can include a first linkage 1140 and a second linkage 1140. The first linkage 1140 can be coupled with a first part of the coupler 1135. The second linkage 1140 can be coupled with a second part of the coupler 1135. The first part of the coupler 1135 can be opposite to the second part of the coupler 1135.

The bike frame adapter 1100 can include at least one linkage hook 1145. The linkage hook 1145 can be coupled with or extend from the linkage 1140. The linkage hook 1145 can be at an end of the linkage 1140. The linkage hook 1145 can pivot about a rotation point. The linkage hook 1145 can contact one or more components of the bike frame adapter 1100 or the top frame 125. For example, the linkage hook 1145 can contact the pin 1115 to couple the top frame 125 with the mount 1105. For example, the link system 1132 can move between a first position and a second position. The first position can be an open position (e.g., the top frame 125 can be removed from contacting the mount 1105). The second position can be a closed or locked position (e.g., the top frame 125 is coupled with the mount 1105). With the link system 1132 in the first position, the top frame 125 can be positioned such that the pin 1115 of the top frame 125 can contact the protrusion 1120 of the mount 1105. With the pin 1115 in contact with the protrusion 1120, the link system 1132 can move to the second position. The second position can include protrusion 1120 being disposed on a first side (e.g., bottom) of the pin 1115 and the linkage hook 1145 being disposed on a second side (e.g., top) of the pin 1115. The linkage hook 1145 can apply a force to the pin 1115 to hold the pin between the linkage hook 1145 and the protrusion 1120.

The link system 1132 can include a plurality of linkage hooks 1145. For example, the link system 1132 can include a first linkage hook 1145 and a second linkage hook 1145. The first linkage hook 1145 can be coupled with the first linkage 1140. The first linkage hook 1145 can contact the first pin 1115. The second linkage hook 1145 can be coupled with the second linkage 1140. The second linkage hook 1145 can contact the second pin 1115. With the first linkage hook 1145 in contact with the first pin 1115 and the second linkage hook 1145 in contact with the second pin 1115, the top frame 125 can be coupled with the mount 1105.

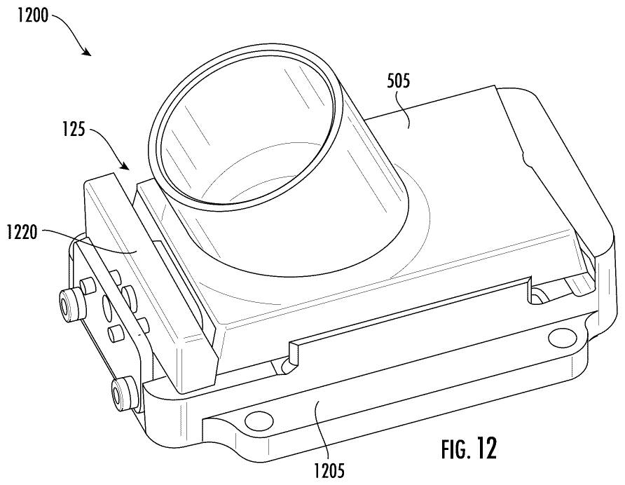

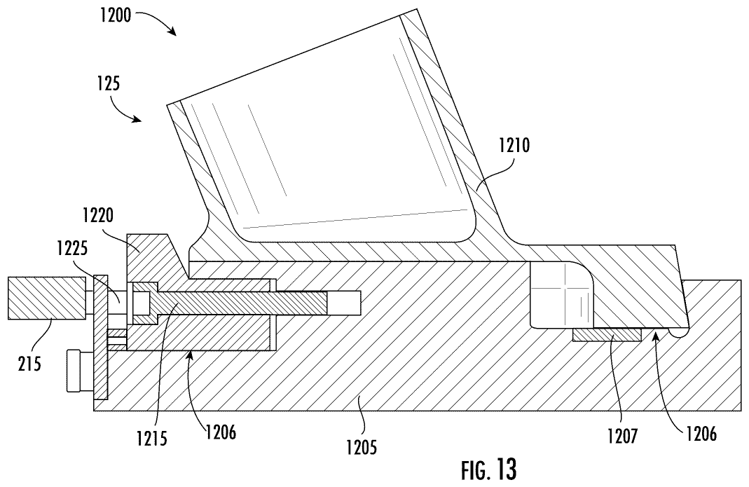

FIGS. 12 and 13 depict an example of a bike frame adapter 1200. The bike frame adapter 1200 can couple a top frame 125 with the bike 100 (e.g., similar to the bike frame adapter 210, among others). The bike frame adapter 1200 can include at least one mount 1205 (e.g., base plate). The mount 1205 can be disposed along or partially within the frame 105. The mount 1205 can be configured to receive at least a portion of the top frame 125. For example, the mount 1205 can define at least one aperture 1206. The aperture 1206 can be configured to receive a portion of the top frame 125. The mount 1205 can include a front aperture 1206 and a rear aperture 1206. The front aperture 1206 can be configured to receive a first portion of the top frame 125 (e.g., a first or front portion of the frame body 505). The rear aperture 1206 can be configured to receive a second portion of the top frame 125 (e.g., a second or rear portion of the frame body 505).

The bike frame adapter 1200 can include at least one sensor 1207. The sensor 1207 can be coupled with the mount 1205. The sensor 1207 can be the same as or similar to the sensor 425, among others. For example, the sensor 1207 can be configured to detect when at least a portion of a top frame 125 is disposed in the cavity 305 of the connection point 120 of the bike 100.

The bike frame adapter 1200 can include at least one actuator 215. The actuator 215 can be coupled with the mount 1205. The actuator 215 can be couple to or disposed within the mount 1205. The actuator 215 can be configured to couple the mount 1205 with or decouple the mount 1205 from the top frame 125. For example, the actuator 215 can actuate in response to the sensor 1207 detecting the top frame 125 or in response to the display 110 receiving a user input.

The bike frame adapter 1200 can include at least one drive member 1215 (e.g., screw). The drive member 1215 can be coupled with the actuator 215. The actuator 215 can cause the drive member 1215 to move or rotate.

The bike frame adapter 1200 can include at least one anchor 1220. The anchor 1220 can be at least partially disposed within the mount 1205. For example, the anchor 1220 can be at least partially disposed within the front aperture 1206. The anchor 1220 can receive a first portion of the frame body 505. The anchor 1220 can be movable within the mount 1205. For example, the anchor 1220 can move between a first position (e.g., unlocked) and a second position (locked). The drive member 1215 can be coupled with the anchor 1220. For example, the drive member 1215 can be threadably coupled with the anchor 1220. For example, the rotation of the drive member 1215 can cause linear movement of the anchor 1220 between a first position and a second position. With the anchor 1220 in the first position, the anchor 1220 can receive the first portion of the frame body 505. With the anchor 1220 in the second position, the anchor 1220 can couple the top frame 125 with the mount 1205 (e.g., prevent the first portion of the frame body 505 from being removed from the cavity 305 and decoupling from the mount 1205.

The bike frame adapter 1200 can include at least one spring 1225. The spring 1225 can bias the anchor 1220 to the first position. The spring 1225 can be coupled with the anchor 1220. The spring 1225 can be coupled with the mount 1205. The linear movement of the anchor 1220 can cause the spring 1225 to compress or decompress. For example, with the frame body 505 in contact with the anchor 1220, the spring 1225 can be compressed. With the anchor 1220 in the second position, the spring 1225 can at least partially decompressed.

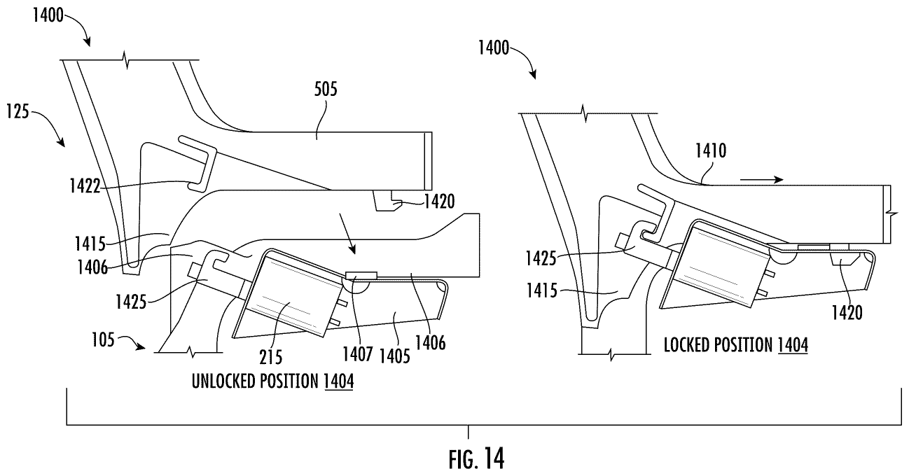

FIG. 14 depicts an example of a bike frame adapter 1400. The bike frame adapter 1400 can move between an unlocked position 1402 and a locked position 1404. The bike frame adapter 1400 can couple a top frame 125 with the bike 100 (e.g., similar to the bike frame adapter 210). The bike frame adapter 1400 can include at least one mount 1405 (e.g., base plate). The mount 1405 can be disposed along or partially within the frame 105. The mount 1405 can be configured to receive at least a portion of the top frame 125. For example, the mount 1405 can define at least one aperture 1406. The aperture 1406 can be configured to receive a portion of the top frame 125. The mount 1405 can include a front aperture 1406 and a rear aperture 1406. The front aperture 1406 can receive a first portion of the top frame 125. The rear aperture 1406 can receive a second portion of the top frame 125.

The bike frame adapter 1400 can include at least one sensor 1407. The sensor 1407 can be coupled with the mount 1405. The sensor 1407 can be the same as or similar to the sensor 425, among others. For example, the sensor 1407 can be configured to detect when at least a portion of a top frame 125 is disposed in the cavity 305 of the connection point 120 of the bike 100.

The bike frame adapter 1400 can include at least one actuator 215. The actuator 215 can be coupled with the mount 1405. The actuator 215 can be disposed within the mount 1405. The actuator 215 can be configured to couple the mount 1405 with or decouple the top frame 125 from the mount 1405. For example, the actuator 215 can actuate in response to the sensor 1407 detecting the top frame 125 or in response to the display 110 receiving a user input.

The top frame 125 can include at least one frame cavity 510. The frame body 505 can define the frame cavity 510. The frame cavity 510 can receive at least a portion of the mount 1405. For example, with the top frame 125 coupled with the mount 1405, at least a portion of the mount 1405 can be disposed in the frame cavity 510.

The top frame 125 can include at least one frame hook 1420. The frame hook 1420 can facilitate proper positioning of the top frame 125 relative to the mount 1405. The frame hook 1420 can couple the top frame 125 with the mount 1405. The frame hook 1420 can be disposed in the frame cavity 510 of the frame body 505. The frame hook 1420 can extend from the frame body 505 into the frame cavity 510. The frame hook 1420 can extend at least partially through the aperture 1206.

The top frame 125 can include a frame lock 1422. The frame lock 1422 can facilitate locking the top frame 125 with the mount 1405. The frame lock 1422 can extend into the frame cavity 510.

The bike frame adapter 1400 can include at least one actuator hook 1425. The actuator hook 1425 can be coupled with the actuator 215. The actuator hook 1425 can extend from the actuator 215. The actuator 215 can cause the actuator hook 1425 to move between a first position (e.g., unlocked) and a second position (e.g., locked). The actuator 215 can move the actuator hook 1425 between the first position and the second position in response to the sensor 1407 detecting the top frame 125 or the display 110 receiving a user input. With the actuator hook 1425 in the first position, the top frame 125 can be decoupled from the mount 1405. With the actuator hook 1425 in the second position, the actuator hook 1425 can engage with (e.g., interface with) the frame lock 1422 to couple the top frame 125 with the mount 1405. The actuator hook 1425 can rotate between the first position and the second position.

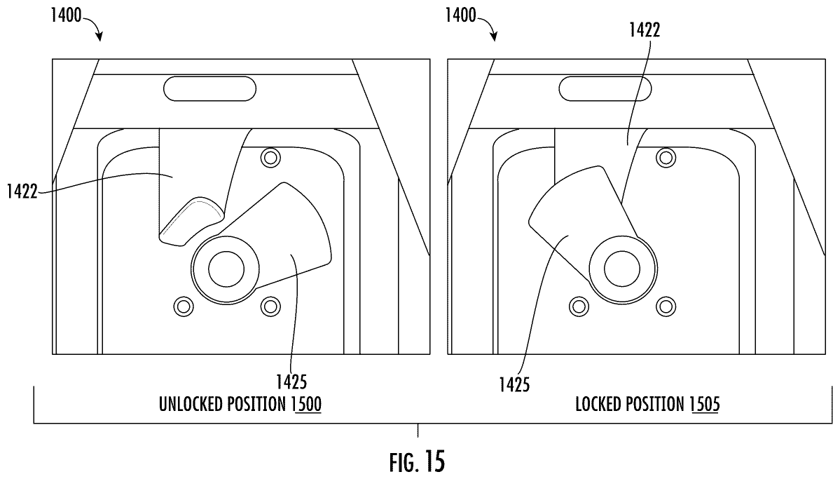

FIG. 15 depicts an example of the actuator hook 1425 of the bike frame adapter 1400 in an unlocked position 1500 (e.g., first position) and a locked position 1505 (e.g., second position). With the actuator hook 1425 in the unlocked position 1500, the actuator hook 1425 can be adjacent to, but not touching, the first frame lock 1422 (e.g., offset from the frame lock 1422). With the actuator hook 1425 in the locked position, the actuator hook 1425 can be aligned with the frame lock 1422. For example, with the actuator hook 1425 in the locked position, the actuator hook 1425 can contact the frame lock 1422.

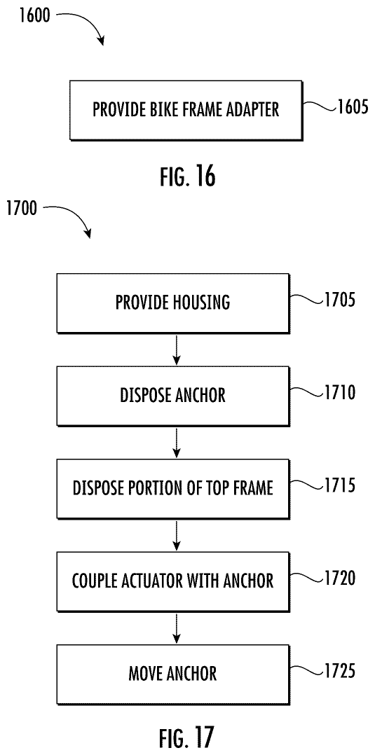

FIG. 16 depicts an example method 1600 of providing a bike frame adapter. Method 1600 can include providing a bike frame adapter (step 1605). The bike frame adapter can be any bike frame adapter described herein. For example, the bike frame adapter can be bike frame adapter 210, 700, 900, 1100, 1200, 1400. As an illustrative example, the bike frame adapter can be bike frame adapter 210. The bike frame adapter 210 can include a housing 405. The housing 405 can define a mount recess 415. The mount recess 415 can receive a portion of a top frame 125. The bike frame adapter 210 can include an anchor 605. The anchor 605 can be disposed at least partially in the mount recess 415. The anchor 605 can move between a first position and a second position. The bike frame adapter 210 can include an actuator 215. The actuator 215 can be coupled with the anchor 605. The actuator 215 can move the anchor 605 between the first position and the second position.

As an illustrative example, the bike frame adapter can be bike frame adapter 700. The bike frame adapter 700 can include a mount 705. The mount 705 can engage at least a portion of a top frame 125. For example, the mount 705 can engage or receive a pin 715. The bike frame adapter 700 can include at least one sensor 707. The sensor 707 can be coupled with the mount 705. The sensor 707 can be configured to detect the presence of a top frame 125. The bike frame adapter 700 can include at least one actuator 215. The actuator 215 can be coupled with the mount 705. The actuator 215 can couple the mount 705 with the top frame 125 in response to the sensor 707 detecting the top frame 125.

As an illustrative example, the bike frame adapter can be bike frame adapter 900. The bike frame adapter can include a mount 905. The mount 905 can engage at least a portion of a top frame 125. For example, a projection 920 of the mount 905 can engage or interface with an engagement element 925 of the top frame 125. The bike frame adapter 900 can include at least one sensor 907. The sensor 907 can be coupled with the mount 905. The sensor 907 can be configured to detect the presence of the top frame 125. The bike frame adapter 900 can include at least one actuator 215. The actuator 215 can be coupled with the mount 905. The actuator 215 can couple the mount 905 with the top frame 125 in response to the sensor 707 detecting the top frame 125.

As an illustrative example, the bike frame adapter can be bike frame adapter 1100. The bike frame adapter 1100 can engage a top frame 125. The bike frame adapter 1100 can include a mount 1105. The mount 1105 can engage at least a portion of the top frame 125. For example, the protrusion 1120 and the link system 1132 of the bike frame adapter 1100 can interface with a pin 1115 of the top frame 125. The bike frame adapter 1100 can include at least one sensor 1107. The sensor 1107 can be configured to detect the presence of the top frame 125. The bike frame adapter 1100 can include at least one actuator 215. The actuator 215 can be coupled with the mount 1105. The actuator 215 can couple the mount 1105 with the top frame 125 in response to the sensor 1107 detecting the top frame 125.

As an illustrative example, the bike frame adapter can be bike frame adapter 1200. The bike frame adapter 1200 can engage a top frame 125. The bike frame adapter 1200 can include a mount 1205. The mount 1205 can engage at least a portion of the top frame 125. For example, an aperture 1206 of the mount 1205 can receive at least a portion of the frame body 505 of the top frame 125. The bike frame adapter 1200 can include at least one sensor 1207. The sensor 1207 can be configured to detect the presence of the top frame 125. The bike frame adapter 1200 can include at least one actuator 215. The actuator 215 can be coupled with the mount 1205. The actuator 215 can couple the mount 1205 with the top frame 125 in response to the sensor 1207 detecting the top frame 125.

As an illustrative example, the bike frame adapter can be bike frame adapter 1400. The bike frame adapter 1400 can engage a top frame 125. The bike frame adapter 1400 can include a mount 1405. The mount 1405 can engage at least a portion of the top frame 125. For example, a frame hook 1420 of the top frame 125 can engage with a front aperture 1406 of the mount 1405. An actuator hook 1425 can engage a frame lock 1422. The bike frame adapter 1400 can include at least one sensor 1407. The sensor 1407 can be configured to detect the presence of the top frame 125. The bike frame adapter 1400 can include at least one actuator 215. The actuator 215 can be coupled with the mount 1405. The actuator 215 can couple the mount 1405 with the top frame 125 in response to the sensor 1407 detecting the top frame 125.

FIG. 17 depicts an example of method 1700 of coupling a top frame with bike frame adapter. As an illustrative example, the bike frame adapter can be bike frame adapter 210. Method 1700 can include providing a housing 405 (step 1705). The housing 405 can define a mount recess 415. Step 1705 can include coupling a sensor 425 with the housing 405. Method 1700 can include disposing an anchor 605 (step 1710). The anchor 605 can be disposed at least partially within the housing 405. The anchor 605 can move between a first position and a second position. Method 1700 can include disposing a portion of the top frame 125 in the mount recess 415 (step 1715). The sensor 425 can detect that the portion of the top frame 125 is disposed in the mount recess 415. Method 1700 can include coupling an actuator 215 with the anchor 605 (step 1720). Step 1720 can include coupling a display 110 with the actuator 215. Method 1700 can include moving the anchor 605 (step 1725). For example, the actuator 215 can move the anchor 605 between a first position and a second position. The actuator 215 can move the anchor 605 responsive to detecting that the portion of the top frame 125 is disposed in the mount recess 415. The actuator 215 can move the anchor 605 responsive to receiving a user input via the display 110.

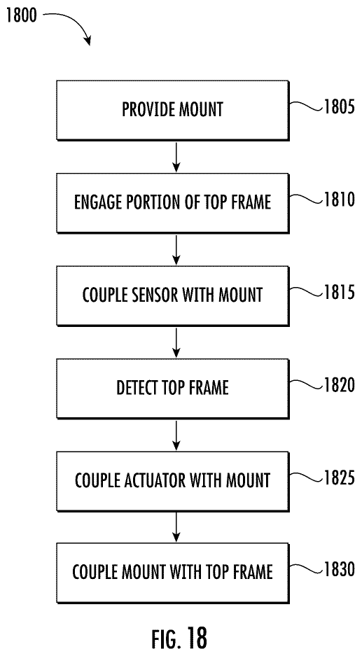

FIG. 18 depicts an example 1800 of coupling a bike frame adapter with a top frame. The bike frame adapter can by any bike frame adapter described herein. For example, the bike frame adapter can be bike frame adapter 210, 700, 900, 1100, 1200, 1400. As an illustrative example, the bike frame adapter can be bike frame adapter 700. Method 1800 can include providing a mount 705 (step 1805). Method 1800 can include engaging a portion of the top frame 125 (step 1810). For example, the mount 705 can engage the portion of the top frame 125. Method 1800 can include coupling a sensor 707 with the mount 705 (step 1815). Method 1800 can include detecting the top frame 125 (step 1820). The sensor 707 can detect the top frame 125. Method 1800 can include coupling an actuator 215 with the mount 705 (step 1825). Step 1825 can include coupling a lock member 725 with the actuator 215. Method 1800 can include coupling the top frame 125 with the mount 705 (step 1830). The actuator 215 can couple the mount 705 with the top frame 125 in response to the sensor 707 detecting the top frame 125. For example, the actuator 215 can move the lock member 725 between a first position and a second position responsive to detecting the top frame 125.

As an illustrative example, the bike frame adapter can be bike frame adapter 900. Method 1800 can include providing a mount 905 (step 1805). Method 1800 can include engaging a portion of the top frame 125 (step 1810). The mount 905 can engage the portion of the top frame 125. Method 1800 can include coupling a sensor 907 with the mount 705 (step 1815). Method 1800 can include detecting the top frame 125 (step 1820). The sensor 907 can detect the top frame 125. Method 1800 can include coupling an actuator 215 with the mount 905 (1825). Method 1800 can include coupling the mount 905 with the top frame 125 (step 1830). The actuator 215 can couple the mount 905 with the top frame 125 in response to the sensor 907 detecting the top frame.

As an illustrative example, the bike frame adapter can be bike frame adapter 1100. Method 1800 can include providing a mount 1105 (step 1805). Method 1800 can include engaging a portion of the top frame 125 (step 1810). The mount 1105 can engage the portion of the top frame 125. Method 1800 can include coupling a sensor 1107 with the mount 1105 (step 1815). Method 1800 can include detecting the top frame 125 (step 1820). The sensor 1107 can detect the top frame 125. Method 1800 can include coupling an actuator 215 with the mount 1105 (1825). Method 1800 can include coupling the mount 1105 with the top frame 125 (step 1830). The actuator 215 can couple the mount 1105 with the top frame 125 in response to the sensor 1107 detecting the top frame.

As an illustrative example, the bike frame adapter can be bike frame adapter 1200. Method 1800 can include providing a mount 1205 (step 1805). Method 1800 can include engaging a portion of the top frame 125 (step 1810). The mount 1205 can engage the portion of the top frame 125. Method 1800 can include coupling a sensor 1207 with the mount 1205 (step 1815). Method 1800 can include detecting the top frame 125 (step 1820). The sensor 1207 can detect the top frame 125. Method 1800 can include coupling an actuator 215 with the mount 1205 (1825). Method 1800 can include coupling the mount 1205 with the top frame 125 (step 1830). The actuator 215 can couple the mount 1205 with the top frame 125 in response to the sensor 1107 detecting the top frame.

As an illustrative example, the bike frame adapter can be bike frame adapter 1400. Method 1800 can include providing a mount 1405 (step 1805). Method 1800 can include engaging a portion of the top frame 125 (step 1810). The mount 1405 can engage the portion of the top frame 125. Method 1800 can include coupling a sensor 1407 with the mount 1205 (step 1815). Method 1800 can include detecting the top frame 125 (step 1820). The sensor 1407 can detect the top frame 125. Method 1800 can include coupling an actuator 215 with the mount 1405 (1825). Method 1800 can include coupling the mount 1405 with the top frame 125 (step 1830). The actuator 215 can couple the mount 1405 with the top frame 125 in response to the sensor 1407 detecting the top frame.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−-10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1.-20. (canceled)

21. A bike frame adapter, comprising:
a mount to engage at least a portion of a top frame;
a sensor coupled with the mount, the sensor to detect the top frame; and
an actuator coupled with the mount, the actuator to couple the mount with the top frame based on the detection of the top frame.

22. The bike frame adapter of claim 21, comprising:
a lock member coupled with the actuator, the actuator to move the lock member between a first position and a second position based on the detection of the top frame.

23. The bike frame adapter of claim 21, comprising:
the actuator coupled with a display, the display to receive a user input;
a lock member coupled with the actuator, the actuator to move the lock member between a first position and a second position based on the user input.

24. The bike frame adapter of claim 21, comprising:
the mount defining an aperture; and
a lock member coupled with the actuator, the actuator to move the lock member from a first position to a second position, a portion of the lock member to extend into the aperture to contact a pin of the top frame in the second position.

25. The bike frame adapter of claim 21, comprising:
a projection coupled with the mount, the projection having a shape, the projection corresponding with an engagement element of the top frame, the engagement element defining a cavity, the shape of the projection to correspond with a shape of the cavity of the engagement element.

26. The bike frame adapter of claim 21, comprising:
a drive member coupled with the actuator, the actuator to rotate the drive member as the actuator couples the top frame with the mount; and
a link system coupled with the drive member, the link system to move from a first position to a second position in response to the rotation of the drive member.

27. The bike frame adapter of claim 21, comprising:
a protrusion coupled with the mount, the protrusion to interface with a pin of the top frame; and
a link system coupled with the actuator, the link system comprising a linkage hook, the pin to be disposed between the linkage hook and the protrusion to couple the top frame with the mount.

28. The bike frame adapter of claim 21, comprising:
an anchor coupled with the mount, the anchor to move from a first position to a second position based on the engagement of the mount with the top frame;
a spring coupled with the anchor, the spring to bias the anchor to the first position; and
a drive member coupled with the anchor and the actuator, the actuator to drive the drive member to lock the anchor in the second position.

29. The bike frame adapter of claim 21, comprising:
a hook coupled with the actuator, the actuator to rotate the hook to interface with a frame lock of the top frame, the hook to pull the top frame toward the mount and couple the top frame with the mount.

30. A bike frame adapter system, comprising:
a top frame comprising a mount plate;
a mount to receive the mount plate;
a sensor coupled with the mount, the sensor to detect the top frame; and
an actuator coupled with the mount, the actuator to couple the mount with the top frame based on the detection of the top frame.

31. The bike frame adapter system of claim 30, comprising:
a lock member coupled with the actuator, the actuator to move the lock member between a first position and a second position based on the detection of the top frame.

32. The bike frame adapter system of claim 30, comprising:
the actuator coupled with a display, the display to receive a user input;
a lock member coupled with the actuator, the actuator to move the lock member between a first position and a second position based on the user input.

33. The bike frame adapter system of claim 30, comprising:
the mount defining an aperture; and
a lock member coupled with the actuator, the actuator to move the lock member from a first position to a second position, a portion of the lock member to extend into the aperture to contact a pin of the top frame in the second position.

34. The bike frame adapter system of claim 30, comprising:
a projection coupled with the mount, the projection having a shape, the projection corresponding with an engagement element of the top frame, the engagement element defining a cavity, the shape of the projection to correspond with a shape of the cavity of the engagement element.

35. The bike frame adapter system of claim 30, comprising:
a drive member coupled with the actuator, the actuator to rotate the drive member as the actuator couples the top frame with the mount; and
a link system coupled with the drive member, the link system to move from a first position to a second position in response to the rotation of the drive member.

36. The bike frame adapter system of claim 30, comprising:
a protrusion coupled with the mount, the protrusion to interface with a pin of the top frame; and
a link system coupled with the actuator, the link system comprising a linkage hook, the pin to be disposed between the linkage hook and the protrusion to couple the top frame with the mount.

37. The bike frame adapter system of claim 30, comprising:
an anchor coupled with the mount, the anchor to move from a first position to a second position in response to the mount receiving the top frame;
a spring coupled with the anchor, the spring to bias the anchor to the first position; and
a drive member coupled with the anchor and the actuator, the actuator to drive the drive member to lock the anchor in the second position.

38. The bike frame adapter system of claim 30, comprising:
a hook coupled with the actuator, the actuator to rotate the hook to interface with a frame lock of the top frame, the hook to pull the top frame toward the mount and couple the top frame with the mount.

39. A method of coupling a top frame with a bike frame adapter, comprising:
providing a mount;
engaging, via the mount, a portion of a top frame;
coupling a sensor with the mount;
detecting, via the sensor, the top frame;
coupling an actuator with the mount; and
coupling, via the actuator, the top frame with the mount in response to detecting the top frame.

40. The method of claim 39, comprising:
coupling a lock member with the actuator;
moving, via the actuator, the lock member between a first position and a second position responsive to detecting the top frame.
